(19) United States
(12) Patent Application Publication
(10) Pub. No.: US 2023/0251135 A1
(43) Pub. Date: Aug. 10, 2023

(54) INFRARED RAMAN MICROSCOPE

(71) Applicant: SHIMADZU CORPORATION, Kyoto (JP)

(72) Inventors: Naoya FUJIWARA, Kyoto (JP); Yusuke AOI, Kyoto (JP)

(73) Assignee: SHIMADZU CORPORATION, Kyoto (JP)

(21) Appl. No.: 18/075,392

(22) Filed: Dec. 5, 2022

(30) Foreign Application Priority Data
Feb. 4, 2022 (JP) 2022-016573

(51) Int. Cl. G01J 3/44; G01J 3/02; G01N 21/65

(52) U.S. Cl. CPC G01J 3/4412; G01J 3/0291; G01N 21/65

(57) ABSTRACT

An analysis result of an infrared spectrum at each measurement position is mapped and displayed in an infrared map display area as infrared data in association with a point of coordinates of each measurement position. An analysis result of a Raman spectrum at each measurement position is mapped and displayed in a Raman map display area as Raman data in association with a point of coordinates of each measurement position. In a case where an optional measurement position is designated in the infrared map display area and the Raman map display area, an infrared spectrum and a Raman spectrum associated with the designated measurement position are graphically displayed in the same graph display area.

### BACKGROUND OF THE INVENTION

### Cross Reference to Related Applications

This application claims priority to Japanese Patent Application No.2022-16573 filed on Feb. 4, 2022, the entire disclosure of which is incorporated by reference herein.

### Field of the Invention

The present invention relates to an infrared Raman microscope capable of switching to and performing infrared spectroscopic analysis or Raman spectroscopic analysis for a sample on a stage.

### Description of the Related Art

As analysis methods for performing analysis by irradiating a sample with light, infrared spectroscopic analysis and Raman spectroscopic analysis are known (see, for example, JP-A-2001-13095). In the infrared spectroscopic analysis, an infrared spectrum is obtained by irradiating a measurement position of a sample with infrared light and measuring light absorption at each wavelength (wave number). On the other hand, in the Raman spectroscopic analysis, a Raman spectrum is obtained by irradiating a measurement position of a sample with light of a specific wavelength and measuring scattered light (Raman scattered light) generated from the sample.

Both the infrared spectrum and the Raman spectrum are vibration spectra based on molecular vibration. The molecular vibration includes a vibration mode appearing as a peak on a spectrum and a vibration mode not appearing as a peak, and appearance of a peak is different between the infrared spectroscopic analysis by absorption and the Raman spectroscopic analysis by scattering. For this reason, if analysis is performed using both the infrared spectrum and the Raman spectrum, more types of substances can be identified.

### SUMMARY OF THE INVENTION

Analysis such as principal component analysis may be performed on an infrared spectrum and a Raman spectrum. When such an analysis result is displayed, for example, as an analysis result at each measurement position is mapped and displayed in association with coordinates of each measurement position, distribution of the analysis results on coordinates can be displayed in a visually understandable manner.

However, in a configuration in which an analysis result of an infrared spectrum and an analysis result of a Raman spectrum are switched, mapped, and displayed, it is not possible to easily compare the analysis results. Further, even in a case where a spectrum is displayed on the basis of each analysis result, an infrared spectrum or a Raman spectrum is separately displayed, and thus, it is not possible to easily compare the spectra.

The present invention has been made in view of the above circumstances, and an object of the present invention is to provide an infrared Raman microscope capable of easily comparing an analysis result of an infrared spectrum with an analysis result of a Raman spectrum, displaying a desired infrared spectrum and Raman spectrum, and easily comparing the infrared spectrum and the Raman spectrum.

A first aspect of the present invention is an infrared Raman microscope capable of switching to and performing infrared spectroscopic analysis or Raman spectroscopic analysis on a sample on a stage, the infrared Raman microscope including an analysis processing unit, an infrared data display processing unit, a Raman data display processing unit, and a graph display processing unit. In a case where a range of coordinates on the stage is designated, the analysis processing unit acquires an infrared spectrum and a Raman spectrum associated with each measurement position by the infrared spectroscopic analysis and the Raman spectroscopic analysis for a plurality of measurement positions within the range. The infrared data display processing unit causes an analysis result of an infrared spectrum at each measurement position to be mapped and displayed as infrared data in an infrared map display area in association with coordinates of each measurement position. Further, the Raman data display processing unit causes an analysis result of a Raman spectrum at each measurement position to be mapped and displayed as Raman data in a Raman map display area in association with coordinates of each measurement position. In a case where an optional measurement position is designated in the infrared map display area and the Raman map display area, the graph display processing unit graphically displays an infrared spectrum and a Raman spectrum associated with the designated measurement position in the same graph display area.

According to the present invention, it is possible to easily compare an analysis result of an infrared spectrum with an analysis result of a Raman spectrum, display a desired infrared spectrum and Raman spectrum, and easily compare the infrared spectrum and the Raman spectrum.

### BRIEF DESCRIPTION OF THE DRAWINGS

FIG. 1 is a schematic view illustrating an example of a configuration example of an infrared Raman microscope.

FIG. 2 is a schematic view illustrating an example of a configuration example of the infrared Raman microscope.

FIG. 3 is a block diagram illustrating an example of an electrical configuration of the infrared Raman microscope.

FIGS. 4A and 4B are diagrams for explaining an aspect when a measurement position is designated, where FIG. 4A illustrates an example of a display screen of a display unit in a case where point measurement is performed, and

FIG. 4B illustrates an example of a display screen of the display unit in a case where map measurement is performed.

FIG. 5 is a diagram specifically illustrating an aspect of designation of a measurement position in a case where map measurement is performed.

FIG. 6 is a diagram illustrating an example of map display.

FIG. 7 is a diagram illustrating an example of a comparison display screen.

FIG. 8 is a functional block diagram illustrating a specific example of an electrical configuration of the infrared Raman microscope.

### DETAILED DESCRIPTION OF THE PREFERRED EMBODIMENTS

### 1. Schematic Configuration of Infrared Raman Microscope

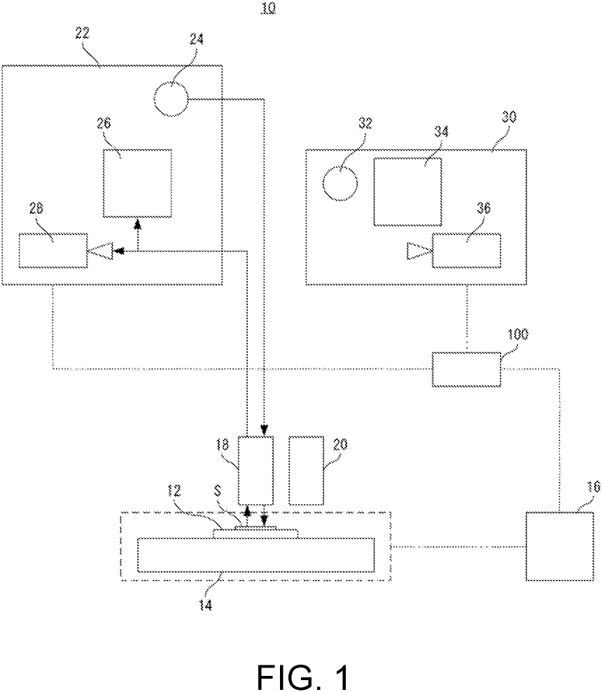

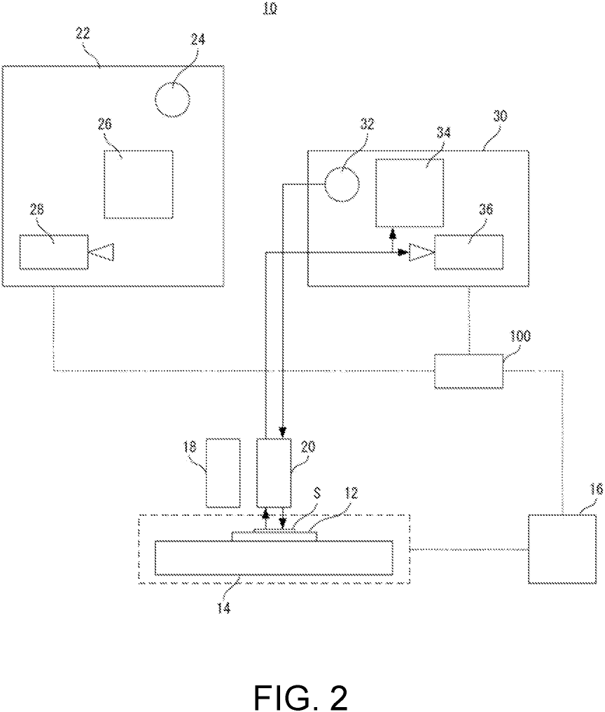

FIGS. 1 and 2 are schematic diagrams illustrating an example of a configuration example of an infrared Raman microscope 10. The infrared Raman microscope 10 according to the present embodiment is a microscope that can switch to and perform the infrared spectroscopic analysis and the Raman spectroscopic analysis on a sample S on a stage 14.

Further, FIG. 1 illustrates a state (Raman analysis state) of the infrared Raman microscope 10 when the Raman spectroscopic analysis is performed, and FIG. 2 illustrates a state (infrared analysis state) of the infrared Raman microscope 10 when the infrared spectroscopic analysis is performed.

The infrared Raman microscope 10 includes a plate 12, the stage 14, a drive unit 16, an objective optical element 18, an objective optical element 20, a Raman light detection system 22, an infrared light detection system 30, and the like. The sample S is placed on the stage 14 in a state of being fixed to the plate 12.

The stage 14 can be displaced in the horizontal direction or the vertical direction by driving of the drive unit 16. The drive unit 16 can be electrically controlled, and the drive unit 16 and the stage 14 are mechanically connected. The drive unit 16 includes, for example, a motor, a gear, and the like.

The objective optical element 18 is used for the Raman spectroscopic analysis, and has a configuration in which, for example, a convex lens and a concave lens are combined. When the Raman spectroscopic analysis is performed, as illustrated in FIG. 1, the objective optical element 18 faces the sample S on the plate 12. That is, the objective optical element 18 is located immediately above the sample S on the plate 12.

The objective optical element 20 is used for the infrared spectroscopic analysis, and is, for example, a Cassegrain mirror obtained by combining a concave mirror and a convex mirror. When the infrared spectroscopic analysis is performed, as illustrated in FIG. 2, the objective optical element 20 faces the sample S on the plate 12. That is, the objective optical element 20 is located immediately above the sample S on the plate 12.

The Raman light detection system 22 is used for performing the Raman spectroscopic analysis, and includes a light source 24, a Raman spectrometer 26, and an optical photographing element 28. Light emitted from the light source 24 is, for example, laser light having a wavelength in a visible range or a near-infrared range, and a wavelength of the laser light is about several µm to several tens µm. As illustrated in FIG. 1, when the Raman spectroscopic analysis is performed, light emitted from the light source 24 is guided to the objective optical element 18 by various optical elements (not illustrated).

Light incident on the objective optical element 18 is focused on the sample S fixed to the plate 12. That is, light from the light source 24 is condensed by being transmitted through the objective optical element 18, and is applied to a focal position on the sample S or in the sample S. Raman scattered light is generated from the sample S irradiated with light from the light source 24, and this light is guided to the Raman light detection system 22 by various optical elements (not illustrated). A part of light guided from the objective optical element 18 to the Raman light detection system 22 enters the optical photographing element 28, and the remaining light enters the Raman spectrometer 26.

The Raman spectrometer 26 detects intensity for each wavelength by dispersing the Raman scattered light from the sample S. Based on a detection signal from the Raman spectrometer 26, a Raman spectrum can be acquired. In the Raman spectrum, the vertical axis represents intensity, and the horizontal axis represents a wave number (Raman shift which is a wave number difference between incident light and scattered light). As described above, in the infrared Raman microscope 10, a Raman spectrum can be acquired as the detector (Raman spectrometer 26) receives Raman scattered light from the sample S.

The optical photographing element 28 photographs a visible image of a surface of the sample S in which Raman scattered light is generated. The optical photographing element 28 includes, for example, a charge coupled device (CCD) image sensor, a complementary metal oxide semiconductor (CMOS) image sensor, or the like, and is configured to be able to photograph a still image or a moving image of the sample S. The optical photographing element 28 can photograph all or at least one of a bright field image, a dark field image, a phase difference image, a fluorescence image, a polarization microscope image, and the like of the sample S.

The infrared light detection system 30 is used for performing the infrared spectroscopic analysis, and includes a light source 32, an infrared spectrometer 34, and an optical photographing element 36. Light emitted from the light source 32 is, for example, infrared light emitted from a ceramic heater, and has a wavelength of about 405 nm to 1064 nm, and in many cases, light obtained by combining wavelengths of 532 nm and 785 nm is used. As illustrated in FIG. 2, when the infrared spectroscopic analysis is performed, light emitted from the light source 32 is guided to the objective optical element 20 by various optical elements (not illustrated).

Light incident on the objective optical element 20 is focused on the sample S fixed to the plate 12. That is, light from the light source 32 is condensed by being transmitted through the objective optical element 20, and is applied to a focal position on the sample S or in the sample S. Reflected light from the sample irradiated with light from the light source 32 is guided to the infrared light detection system 30 by various optical elements (not illustrated). A part of the light guided from the objective optical element 20 to the infrared light detection system 30 enters the optical photographing element 36, and the remaining light enters the infrared spectrometer 34.

The infrared spectrometer 34 is, for example, a Fourier transform infrared spectrometer. A spectroscope included in the infrared spectrometer 34 may be a Michelson interference spectroscope. The infrared spectrometer 34 detects intensity for each wavelength by dispersing reflected light of infrared light from the sample. An infrared spectrum can be acquired on the basis of a detection signal from the infrared spectrometer 34. In an infrared spectrum, the vertical axis represents intensity, and the horizontal axis represents a wavelength. As described above, in the infrared Raman microscope 10, an infrared spectrum can be acquired as the detector (infrared spectrometer 34) receives reflected light of infrared light from the sample S.

The optical photographing element 36 photographs a visible image of a surface of the sample S from which infrared light is reflected. The optical photographing element 36 may have a configuration similar to that of the optical photographing element 28. Similarly to the optical photographing element 28, the optical photographing element 36 can photograph a still image or a moving image of the sample S, and can photograph all or at least one of a bright field image, a dark field image, a phase difference image, a fluorescence image, a polarization microscope image, and the like of the sample S.

As described above, in the infrared Raman microscope 10 according to the present embodiment, switching between the infrared spectroscopic analysis and the Raman spectroscopic analysis is enabled, and in a case where switching is made from the infrared spectroscopic analysis to the Raman spectroscopic analysis, a positional relationship between the objective optical element 18 and the plate 12 is adjusted, so that a focal position of light condensed by the objective optical element 18 is adjusted to a predetermined measurement position of a sample. On the other hand, in a case where switching is made from the Raman spectroscopic analysis to the infrared spectroscopic analysis, a positional relationship between the objective optical element 20 and the plate 12 is adjusted, so that a focal position of light condensed by the objective optical element 20 is adjusted to a predetermined measurement position of a sample.

### 2. Electrical Configuration of Infrared Raman Microscope

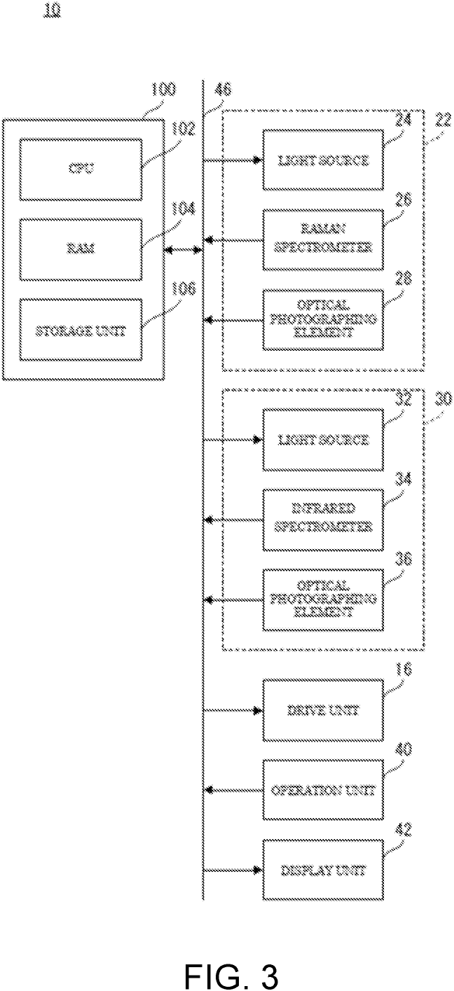

FIG. 3 is a block diagram illustrating an example of an electrical configuration of the infrared Raman microscope 10. The infrared Raman microscope 10 includes an operation unit 40, a display unit 42, a control unit 100, and the like in addition to the drive unit 16, the Raman light detection system 22, the infrared light detection system 30, and the like.

Further, each of the control unit 100, the drive unit 16, the light source 24, the Raman spectrometer 26, the optical photographing element 28, the light source 32, the infrared spectrometer 34, the optical photographing element 36, the operation unit 40, and the display unit 42 is electrically connected to each other via a circuit 46 such as a bus.

The control unit 100 is responsible for overall control of the infrared Raman microscope 10. The control unit 100 includes a central processing unit (CPU) 102. Further, the control unit 100 includes a random access memory (RAM) 104 and a storage unit 106 that can be directly accessed by the CPU 102.

The RAM 104 is used as a work area and a buffer area of the CPU 102. The storage unit 106 is a non-volatile memory, and for example, a hard disc drive (HDD), a solid state drive (SSD), or the like is used as the storage unit 106.

The storage unit 106 stores a control program for controlling the infrared Raman microscope 10, data (execution data) required for executing the control program, and the like. Note that the storage unit 106 may be configured to include the RAM 104.

The operation unit 40 includes a hardware key (operation key). Further, the operation unit 40 may include an input device. Examples of the input device include a keyboard and a mouse. Furthermore, the input device may include a touch panel. Note that, in this case, the touch panel is provided on a display screen of the display unit 42. Further, the touch panel and the display unit 42 may be integrally formed. Note that the display unit 42 is a general-purpose display.

### 3. Designation of Measurement Position

A measurement position when the infrared spectroscopic analysis or the Raman spectroscopic analysis is performed can be designated on a visible image of the sample S displayed on the display unit 42. The measurement position is an optional position selected in a horizontal plane. In the present embodiment, it is possible to select and execute point measurement in which an optional measurement position is designated one by one on a visible image of the sample S and measurement of each point is performed, or map measurement in which a range is designated on a visible image of the sample S and measurement of each point (each measurement position) within the range is performed.

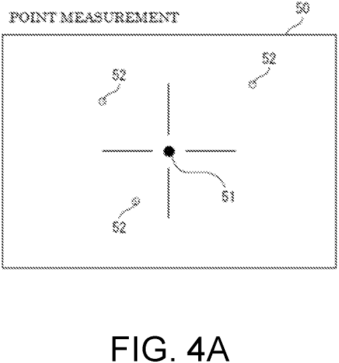

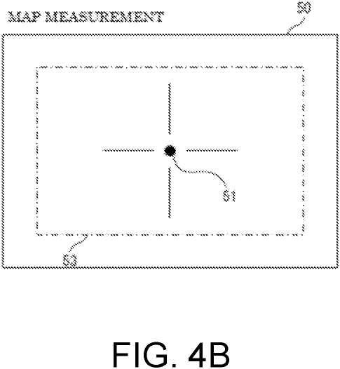

FIGS. 4A and 4B are diagrams for explaining an aspect when a measurement position is designated, where FIG. 4A illustrates an example of a display screen of the display unit 42 in a case where point measurement is performed, and FIG. 4B illustrates an example of a display screen of the display unit 42 in a case where map measurement is performed. At this time, on a display screen of the display unit 42, a visible image 50 of the sample S is displayed in real time on the basis of a signal from the optical photographing element 28 or the optical photographing element 36. However, the visible image 50 of the sample S displayed on the display unit 42 may be a still image acquired at a predetermined timing.

Further, in the present embodiment, map information is stored in the storage unit 106 in a data format in advance. The map information is information indicating coordinates, specifically, two-dimensional coordinates, on the stage 14. The visible image 50 is displayed in association with coordinates on the stage 14. Therefore, in a case where a measurement position is designated on the visible image 50, a point on coordinates corresponding to the measurement position is designated. In the infrared spectroscopic analysis or the Raman spectroscopic analysis, measurement is performed after an optical axis position of light from the light source 24 or the light source 32 is matched with a designated point (measurement position) on coordinates.

The center of the visible image 50 is an optical axis position 51 of light from the light source 24 or the light source 32. Therefore, an operator can designate an optional measurement position around the optical axis position 51 on the visible image 50 with reference to the optical axis position 51. A measurement position can be designated by operation on the operation unit 40. For example, in a case where the operation unit 40 includes a pointing device such as a mouse, a measurement position can be easily designated by click operation, drag operation, or the like.

Note that a magnification of the visible image 50 can be adjusted by an operator operating the operation unit 40, and scale of coordinates on the stage 14 corresponding to the visible image 50 is also changed with a change in a magnification of the visible image 50. Therefore, an operator can designate an optional measurement position on the visible image 50 after increasing or decreasing a magnification of the visible image 50. Further, an operator can adjust a position of a surface image of the sample S displayed as the visible image 50 by operating the operation unit 40.

In a case where point measurement is performed, as illustrated in FIG. 4A, an optional measurement position 52 on the visible image 50 can be designated one by one. In this manner, a point of coordinates on the stage 14 corresponding to the designated measurement position 52 is designated. At this time, an operator can designate one or a plurality of the measurement positions 52 by click operation using a pointing device. The example illustrated in FIG. 4A illustrates a case where three of the measurement positions 52 are selected.

On the other hand, in a case where map measurement is performed, as illustrated in FIG. 4B, an optional range 53 on the visible image 50 can be designated. In this manner, a range of coordinates on the stage 14 corresponding to the designated range 53 is designated. At this time, an operator can designate the range 53 on the visible image 50 by drag operation using a pointing device.

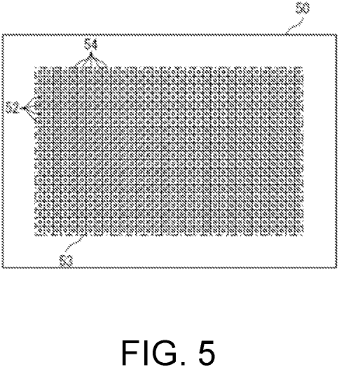

FIG. 5 is a diagram specifically illustrating an aspect of designation of a measurement position in a case where map measurement is performed. In a case where an optional one of the range 53 on the visible image 50 is designated as illustrated in FIG. 4B, one point in each grid-like measurement area 54 when the range 53 is divided into a plurality of the measurement areas 54 is designated as the measurement position 52.

In the example of FIG. 5, an optional one of the range 53 on the visible image 50 designated is divided into the measurement areas 54 of a predetermined size, so that a plurality of the measurement areas 54 are arranged in a grid-like manner within the range 53. One point (for example, a center point) in each of the measurement areas 54 is the measurement position 52, and, as an optional one of the range 53 is designated, each of the measurement positions 52 located at equal intervals within the range 53 can be designated.

### 4. Map Display

As illustrated in FIG. 5, in a case where an optional one of the range 53 on the visible image 50 is designated so that a range of coordinates on the stage 14 is designated, the infrared spectroscopic analysis and the Raman spectroscopic analysis are performed for a plurality of the measurement positions 52 within the range 53. In this manner, an infrared spectrum and a Raman spectrum associated with each of the measurement positions 52 can be acquired. Further, the acquired infrared spectrum and Raman spectrum at each of the measurement positions 52 can be analyzed, and a result of the analysis can be displayed on the display unit 42.

The above analysis is analysis of a characteristic of a spectrum (infrared spectrum and Raman spectrum) at each of the measurement positions 52, and for example, a calculation result of a peak height of a peak included in a spectrum at each of the measurement positions 52, a calculation result of a peak area, a result of multivariate analysis, or the like is obtained as an analysis result of a spectrum at each of the measurement positions 52. The obtained analysis result at each of the measurement positions 52 is represented in a mode in which a difference in analysis results can be visually identified by color, density, or the like in the measurement areas 54 of the range 53 designated on the visible image 50. As a result, a plurality of the measurement areas 54 arranged in a grid-like manner are represented by different colors, densities, or the like, so that distribution of analysis results at each of the measurement positions 52 is mapped and displayed.

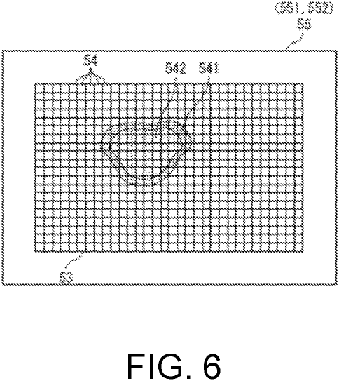

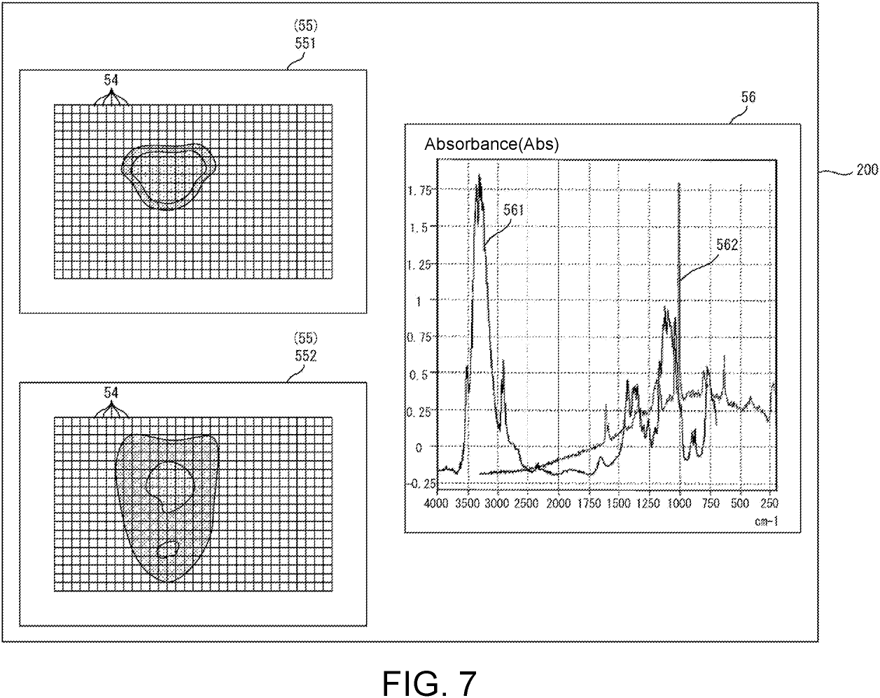

FIG. 6 is a diagram illustrating an example of map display. In a case where map measurement is performed, an analysis result at each of the measurement positions 52 is mapped and displayed in a map display area 55 displayed on the display unit 42 based on operation of the operation unit 40 by an operator. As will be described later, in the present embodiment, an infrared map display area 551 for map display of an analysis result of an infrared spectrum at each of the measurement positions 52 and a Raman map display area 552 for map display of an analysis result of a Raman spectrum at each of the measurement positions 52 are displayed on the display unit 42 (see FIG. 7). Therefore, description on the map display area 55 using FIG. 6 applies to both the infrared map display area 551 and the Raman map display area 552.

As illustrated in FIG. 6, the range 53 on the visible image 50 designated in FIG. 5 is displayed in the map display area 55. The range 53 is divided into a plurality of the measurement areas 54 arranged in a grid-like manner similarly to FIG. 5, and each of the measurement positions 52 is associated with each of the measurement areas 54. Therefore, an analysis result of a spectrum at each of the measurement positions 52 is mapped and displayed in the map display area 55 in association with coordinates (coordinates on the stage 14) of each of the measurement positions 52. That is, in the infrared map display area 551, an analysis result of an infrared spectrum at each of the measurement positions 52 is mapped and displayed as infrared data, and in the Raman map display area 552, an analysis result of a Raman spectrum at each of the measurement positions 52 is mapped and displayed as Raman data. Note that a visible image of a surface of the sample S may be superimposed and displayed in the infrared map display area 551 and the Raman map display area 552.

In the example of FIG. 6, a color or density of a partial measurement area 541 is displayed in a mode different from a color or density of another partial measurement area 542. In this manner, it is possible to visually recognize that an analysis result of a spectrum is different between the measurement position 52 corresponding to the measurement area 541 and the measurement position 52 corresponding to the measurement area 542. An operator can designate an optional one of the measurement areas 54 with reference to map display of the map display area 55 to display a spectrum (infrared spectrum or Raman spectrum) associated with the designated one of the measurement areas 54 (measurement position 52).

In a case where a calculation result of a peak height of a peak included in a spectrum at each of the measurement positions 52 is mapped and displayed as an analysis result of the spectrum, for example, each of the measurement areas 54 is represented by a color or density corresponding to a peak height in a predetermined wave number range. Therefore, an operator can check distribution of peak heights in each of the measurement areas 54 by viewing map display of the map display area 55.

In a case where a calculation result of a peak area of a peak included in a spectrum at each of the measurement positions 52 is mapped and displayed as an analysis result of the spectrum, for example, each of the measurement areas 54 is represented by a color or density corresponding to a peak area in a predetermined wave number range. Therefore, an operator can check distribution of peak areas in each of the measurement areas 54 by viewing map display of the map display area 55.

In a case where a result of multivariate analysis of a spectrum at each of the measurement positions 52 is mapped and displayed as an analysis result of the spectrum, for example, each of the measurement areas 54 is displayed in a color or density corresponding to a type of a component obtained by the multivariate analysis. Specifically, in a case where principal component analysis (PCA) is performed as multivariate analysis, each of the measurement areas 54 may be displayed in a color or density corresponding to a type of a first principal component obtained. Further, in a case where multivariate curve resolution (MCR) is performed as multivariate analysis, each of the measurement areas 54 may be displayed in a color or density corresponding to a type of a first component obtained.

### 5. Comparison Display

FIG. 7 is a diagram illustrating an example of a comparison display screen 200. The comparison display screen 200 is a screen for comparing and checking a result of the infrared spectroscopic analysis and a result of the Raman spectroscopic analysis, and is an example of an operation screen on which an operator can perform input operation. The comparison display screen 200 includes an infrared map display area 551, a Raman map display area 552, and a graph display area 56.

In the infrared map display area 551, an analysis result of an infrared spectrum at each of the measurement positions 52 is mapped and displayed within a range of predetermined coordinates on the stage 14. A range of coordinates mapped and displayed can be adjusted by an operator operating the operation unit 40. Therefore, an operator can adjust a range of desired coordinates to be displayed in the infrared map display area 551, and can check distribution of an analysis result at each of the measurement positions 52 (each of the measurement areas 54) within the range.

In the Raman map display area 552, an analysis result of a Raman spectrum at each of the measurement positions 52 is mapped and displayed within a range of predetermined coordinates on the stage 14. A range of coordinates mapped and displayed can be adjusted by an operator operating the operation unit 40. Therefore, an operator can adjust a range of desired coordinates to be displayed in the Raman map display area 552, and can check distribution of an analysis result at each of the measurement positions 52 (each of the measurement areas 54) within the range.

In the infrared map display area 551 and the Raman map display area 552, a range of coordinates mapped and displayed may be the same or different. Further, in the infrared map display area 551 and the Raman map display area 552, scale of coordinates mapped and displayed may be the same or different. An operator may be able to individually adjust scale of coordinates of the infrared map display area 551 and the Raman map display area 552 by operating the operation unit 40.

In the graph display area 56, an infrared spectrum 561 and a Raman spectrum 562 are graphically displayed. An operator can designate the measurement position 52 corresponding to the measurement area 54 by selecting an optional one of the measurement areas 54 in each of the infrared map display area 551 and the Raman map display area 552. In a case where an optional one of the measurement positions 52 is designated in the infrared map display area 551 and the Raman map display area 552, the infrared spectrum 561 and the Raman spectrum 562 associated with the designated measurement position 52 are graphically displayed in the same graph display area 56. Note that, in the graph display area 56, the infrared spectrum 561 and the Raman spectrum 562 are displayed in an overlapping manner with the horizontal axis representing a wave number and the vertical axis representing intensity.

When the infrared spectrum 561 and the Raman spectrum 562 are displayed in the graph display area 56, as illustrated in FIG. 7, scale of an intensity value of at least one of the infrared spectrum 561 and the Raman spectrum 562 graphically displayed in the graph display area 56 may be adjusted and displayed so that peak heights of the spectra 561 and 562 coincide with each other. That is, scale of the vertical axis of the infrared spectrum 561 may be adjusted to match with a peak height of the Raman spectrum 562, scale of the vertical axis of the Raman spectrum 562 may be adjusted to match with a peak height of the infrared spectrum 561, or scale of the vertical axis of both the infrared spectrum 561 and the Raman spectrum 562 may be adjusted to the same peak height.

### 6. Specific Example of Electrical Configuration

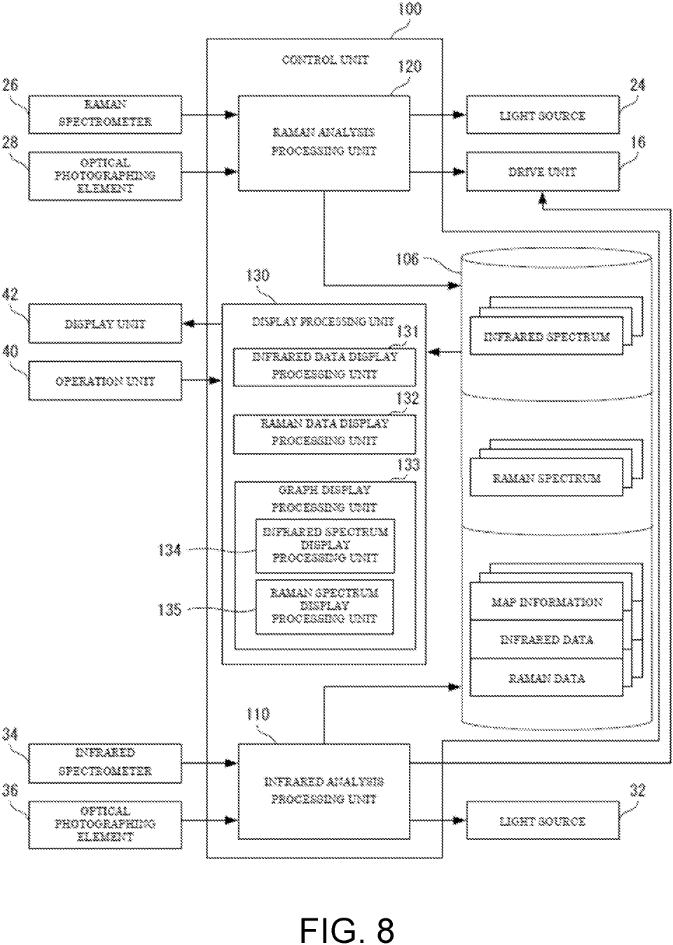

FIG. 8 is a functional block diagram illustrating a specific example of an electrical configuration of the infrared Raman microscope 10. The control unit 100 functions as an infrared analysis processing unit 110, a Raman analysis processing unit 120, a display processing unit 130, and the like when the CPU 102 (see FIG. 3) executes a program.

The infrared analysis processing unit 110 executes processing for performing the infrared spectroscopic analysis on the sample on the stage 14. That is, a sample is irradiated with infrared light collected from the light source 32, and an infrared spectrum is acquired based on a detection signal from the infrared spectrometer 34. Further, the infrared analysis processing unit 110 can acquire a surface image of a sample during the infrared spectroscopic analysis on the basis of a visible image photographed by the optical photographing element 36. At the time of the infrared spectroscopic analysis, analysis may be performed while the stage 14 is moved by control of the drive unit 16.

The Raman analysis processing unit 120 executes processing for performing the Raman spectroscopic analysis on a sample on the stage 14. That is, a sample is irradiated with laser light collected from the light source 24, and a Raman spectrum is acquired based on a detection signal from the Raman spectrometer 26. Further, the Raman analysis processing unit 120 can acquire a surface image of a sample during the Raman spectroscopic analysis on the basis of a visible image photographed by the optical photographing element 28. At the time of the Raman spectroscopic analysis, analysis may be performed while the stage 14 is moved by control of the drive unit 16.

The infrared analysis processing unit 110 and the Raman analysis processing unit 120 function as an analysis processing unit that acquires an infrared spectrum and a Raman spectrum associated with each of the measurement positions 52 by the infrared spectroscopic analysis and the Raman spectroscopic analysis for a plurality of the measurement positions 52 (see FIG. 5) within the range 53 of coordinates on the stage 14 in a case where the range 53 is designated as illustrated in FIG. 4B at the time of map measurement.

Data during the infrared spectroscopic analysis obtained by processing of the infrared analysis processing unit 110 and data during the Raman spectroscopic analysis obtained by processing of the Raman analysis processing unit 120 are stored in the storage unit 106. The storage unit 106 stores, for example, a Raman spectrum acquired by the Raman spectroscopic analysis and an infrared spectrum acquired by the infrared spectroscopic analysis. Further, the storage unit 106 stores an analysis result (infrared data) of an infrared spectrum at each measurement position 52 and an analysis result (Raman data) of a Raman spectrum at each of the measurement positions 52 in association with coordinates (map information) on the stage 14.

The display processing unit 130 controls display on the display unit 42. That is, under control of the display processing unit 130, various screens such as an operation screen are displayed on a display screen of the display unit 42. When an operation screen is displayed on the display unit 42, input operation on the operation screen can be performed by operation of the operation unit 40. When input operation is performed using the operation unit 40, input information (numerical value or the like) is reflected and displayed on an operation screen of the display unit 42.

The display processing unit 130 includes an infrared data display processing unit 131, a Raman data display processing unit 132, and a graph display processing unit 133. Further, the graph display processing unit 133 includes an infrared spectrum display processing unit 134 and a Raman spectrum display processing unit 135.

In a case where map measurement is performed, the infrared data display processing unit 131 causes an analysis result of an infrared spectrum at each of the measurement positions 52 to be mapped and displayed as infrared data in the infrared map display area 551 in association with a point of coordinates of each of the measurement positions 52. Further, the Raman data display processing unit 132 causes an analysis result of a Raman spectrum at each of the measurement positions 52 to be mapped and displayed as Raman data in the Raman map display area 552 in association with a point of coordinates of each of the measurement positions 52.

In a case where an optional one of the measurement positions 52 is designated in the infrared map display area 551 and the Raman map display area 552, the graph display processing unit 133 graphically displays the infrared spectrum 561 and the Raman spectrum 562 associated with the designated measurement position 52 in the same graph display area 56. Specifically, the infrared spectrum display processing unit 134 graphically displays the infrared spectrum 561 in the graph display area 56, and the Raman spectrum display processing unit 135 graphically displays the Raman spectrum 562 in the graph display area 56. At this time, scale of an intensity value of at least one of the infrared spectrum 561 and the Raman spectrum 562 graphically displayed in the graph display area 56 is adjusted so that peak heights of the spectra 561 and 562 coincide with each other.

### 5. Aspect

It is understood by those skilled in the art that a plurality of the exemplary embodiments described above are specific examples of an aspect below.

(Item 1) An infrared Raman microscope according to an aspect includes an infrared Raman microscope capable of performing infrared spectroscopic analysis or Raman spectroscopic analysis on a sample on a stage. The infrared Raman microscope may include:
an analysis processing unit that, in a case where a range of coordinates on the stage is designated, acquires an infrared spectrum and a Raman spectrum associated with each measurement position by infrared spectroscopic analysis and Raman spectroscopic analysis for a plurality of measurement positions within the range;
an infrared data display processing unit that causes an analysis result of an infrared spectrum at each measurement position to be mapped and displayed as infrared data in an infrared map display area in association with a point of coordinates of each measurement position;
a Raman data display processing unit that causes an analysis result of a Raman spectrum at each measurement position to be mapped and displayed as Raman data in a Raman map display area in association with a point of coordinates of each measurement position; and
a graph display processing unit that, in a case where an optional measurement position is designated in the infrared map display area and the Raman map display area, graphically displays an infrared spectrum and a Raman spectrum associated with the designated measurement position in the same graph display area.

According to the infrared Raman microscope described in Item 1, it is possible to easily compare an analysis result of an infrared spectrum at each measurement position mapped and displayed in the infrared map display area with an analysis result of a Raman spectrum at each measurement position mapped and displayed in the Raman map display area. Further, by designating an optional measurement position in the infrared map display area and the Raman map display area, it is possible to graphically display a desired infrared spectrum and Raman spectrum in a graph display area. At this time, since the infrared spectrum and the Raman spectrum are graphically displayed in the same graph display area, the infrared spectrum and the Raman spectrum can be easily compared.

(Item 2) In the infrared Raman microscope according to Item 1, at least one of the infrared map display area and the Raman map display area may be divided into a plurality of measurement areas in a grid-like manner, and each measurement position may be associated with each of the measurement areas.

According to the infrared Raman microscope described in Item 2, by selecting an optional measurement area in the infrared map display area or the Raman map display area divided into a plurality of measurement areas in a grid-like manner, it is possible to easily designate a measurement position corresponding to the measurement area.

(Item 3) In the infrared Raman microscope according to Item 1 or 2, an analysis result of an infrared spectrum at each measurement position may be a calculation result of a peak height of a peak included in an infrared spectrum at each measurement position, a calculation result of a peak area, or a result of multivariate analysis.

According to the infrared Raman microscope described in Item 3, as an analysis result of an infrared spectrum at each measurement position, a calculation result of a peak height of a peak included in an infrared spectrum at each measurement position, a calculation result of a peak area, or a result of multivariate analysis can be mapped and displayed in a visually easily understandable manner.

(Item 4) In the infrared Raman microscope according to any one of Items 1 to 3, an analysis result of a Raman spectrum at each measurement position may be a calculation result of a peak height of a peak included in a Raman spectrum at each measurement position, a calculation result of a peak area, or a result of multivariate analysis.

According to the infrared Raman microscope described in Item 4, as an analysis result of a Raman spectrum at each measurement position, a calculation result of a peak height of a peak included in a Raman spectrum at each measurement position, a calculation result of a peak area, or a result of multivariate analysis can be mapped and displayed in a visually easily understandable manner.

(Item 5) In the infrared Raman microscope according to any one of Items 1 to 4, the graph display processing unit adjusts and displays scale of an intensity value of at least one of an infrared spectrum and a Raman spectrum graphically displayed in the graph display area.

According to the infrared Raman microscope described in Item 5, scale of an intensity value of at least one of an infrared spectrum and a Raman spectrum graphically displayed in the graph display area can be adjusted, so that the infrared spectrum and the Raman spectrum can be easily compared.

What is claimed is:

1. An infrared Raman microscope capable of switching to and performing infrared spectroscopic analysis or Raman spectroscopic analysis on a sample on a stage, the infrared Raman microscope comprising:
an analysis processing unit that, in a case where a range of coordinates on the stage is designated, acquires an infrared spectrum and a Raman spectrum associated with each measurement position by infrared spectroscopic analysis and Raman spectroscopic analysis for a plurality of measurement positions within the range;
an infrared data display processing unit that causes an analysis result of an infrared spectrum at each measurement position to be mapped and displayed as infrared data in an infrared map display area in association with a point of coordinates of each measurement position;
a Raman data display processing unit that causes an analysis result of a Raman spectrum at each measurement position to be mapped and displayed as Raman data in a Raman map display area in association with a point of coordinates of each measurement position; and
a graph display processing unit that, in a case where an optional measurement position is designated in the infrared map display area and the Raman map display area, graphically displays an infrared spectrum and a Raman spectrum associated with the designated measurement position in a same graph display area.

2. The infrared Raman microscope according to claim 1, wherein
at least one of the infrared map display area and the Raman map display area is divided into a plurality of measurement areas in a grid-like manner, and each measurement position is associated with each of the measurement areas.

3. The infrared Raman microscope according to claim 1, wherein
an analysis result of an infrared spectrum at each measurement position is a calculation result of a peak height of a peak included in an infrared spectrum at each measurement position, a calculation result of a peak area, or a result of multivariate analysis.

4. The infrared Raman microscope according to claim 1, wherein
an analysis result of a Raman spectrum at each measurement position is a calculation result of a peak height of a peak included in a Raman spectrum at each measurement position, a calculation result of a peak area, or a result of multivariate analysis.

5. The infrared Raman microscope according to claim 1, wherein
the graph display processing unit adjusts and displays scale of an intensity value of at least one of an infrared spectrum and a Raman spectrum graphically displayed in the graph display area.
